(19) United States
(12) Patent Application Publication
(10) Pub. No.: US 2025/0252357 A1
(43) Pub. Date: Aug. 7, 2025

(54) METHOD AND ELECTRONIC DEVICE FOR TRAINING ARTIFICIAL INTELLIGENCE MODEL FOR INFERRING POSITION INFORMATION

(71) Applicant: Samsung Electronics Co., Ltd., Suwon-si (KR)

(72) Inventor: Hoon HWANGBO, Suwon-si (KR)

(21) Appl. No.: 19/187,235

(22) Filed: Apr. 23, 2025

Related U.S. Application Data
(63) Continuation of application No. PCT/KR2023/015853, filed on Oct. 13, 2023.

(30) Foreign Application Priority Data
Oct. 25, 2022 (KR) 10-2022-0138457

(51) Int. Cl. G06N 20/00; G01S 1/20

(52) U.S. Cl. CPC G06N 20/00; G01S 1/20

(57) ABSTRACT

A method of training an artificial intelligence model for inferring position information is provided. The method includes identifying a first data set including first signal data for a signal device collected at a first position by a user terminal, data for an obstacle located within a certain distance from the user terminal when collecting the first signal data, and second signal data for the signal device collected at a second position, generating a second data set by filtering out the first signal data from the first data set, based on the data for the obstacle, generating a third data set by generating augmented data for the first position and the signal device, based on the second signal data, and training an artificial intelligence model for inferring position information by using the third data set.

### CROSS-REFERENCE TO RELATED APPLICATION(S)

This application is a continuation application, claiming priority under 35 U.S.C. § 365 (c), of an International application No. PCT/KR2023/015853, filed on Oct. 13, 2023, which is based on and claims the benefit of a Korean patent application number 10-2022-0138457, filed on Oct. 25, 2022, in the Korean Intellectual Property Office, the disclosure of which is incorporated by reference herein in its entirety.

### BACKGROUND

### 1. Field

The disclosure relates to a method and an electronic device for training an artificial intelligence model for inferring position information. More particularly, the disclosure relates to a method of inferring position information of a user terminal.

### 2. Description of Related Art

With the advancement of communication technology, users are allowed to receive communication services anywhere by using wireless fidelity (wi-fi) signals. Wi-fi signals may be transmitted and received between an access point (AP) device and a user terminal. As the distance between the user terminal and the AP device increases, the strength of the wi-fi signal gets weaker, and as the distance between the user terminal and the AP device decreases, the strength of the wi-fi signal gets stronger. In addition, the distance between the user terminal and the AP device may be calculated by using the round trip time (RTT) of the wi-fi signal. In addition, the wi-fi signals transmitted from respective AP device to the user terminal may be distinguished.

On the other hand, in addition to communication between the user terminal and the AP device, short-range communication between the user terminals is enabled. For example, short-range communication through Bluetooth signals is enabled between the user terminals. Bluetooth signals received from different user terminals may be distinguished from each other. For example, a Bluetooth signal of a first user terminal and a Bluetooth signal of a second user terminal may be distinguished from each other.

The above information is presented as background information only to assist with an understanding of the disclosure. No determination has been made, and no assertion is made, as to whether any of the above might be applicable as prior art with regard to the disclosure.

### SUMMARY

The disclosure may be implemented in various manners, including a method, a system, a device, or a computer program stored on a computer-readable storage medium.

Aspects of the disclosure are to address at least the above-mentioned problems and/or disadvantages and to provide at least the advantages described below. Accordingly, an aspect of the disclosure is to provide a method and an electronic device for training an artificial intelligence model for inferring position information.

Additional aspects will be set forth in part in the description which follows and, in part, will be apparent from the description, or may be learned by practice of the presented embodiments.

In accordance with an aspect of the disclosure, a method of training an artificial intelligence model for inferring position information is provided. The method includes identifying a first data set including first signal data for a signal device collected at a first position by a user terminal, data for an obstacle located within a certain distance from the user terminal when collecting the first signal data, and second signal data for the signal device collected at a second position, generating a second data set by filtering out the first signal data from the first data set, based on the data for the obstacle, generating a third data set by generating augmented data for the first position and the signal device, based on the second signal data, and training an artificial intelligence model for inferring position information by using the third data set.

In accordance with another aspect of the disclosure, a method of inferring position information of a user terminal is provided. The method includes identifying signal data for one or more signal devices and data for an obstacle located within a certain distance from the user terminal, calculating first position prediction data, based on the signal data for the one or more signal devices, by using an artificial intelligence model for inferring position information, The method includes applying a weight value to the first position prediction data, based on the data for the obstacle and determining the position information of the user terminal, based on the first position prediction data to which the weight value is applied.

In accordance with another aspect of the disclosure, an electronic device for training an artificial intelligence model for inferring position information of a user terminal is provided. The electronic device includes memory storing one or more computer programs and at least one processor communicatively coupled to the memory, wherein the one or more computer programs include computer-executable instructions that, when executed by the at least one processor individually or collectively, cause the electronic device to identify a first data set including first signal data for a signal device collected at a first position by a user terminal, data for an obstacle located within a certain distance from the user terminal when collecting the first signal data, and second signal data for the signal device collected at a second position, generate a second data set by filtering out the first signal data from the first data set, based on the data for the obstacle, generate a third data set by generating augmented data for the first position and the signal device, based on the second signal data, and train the artificial intelligence model by using the third data set.

In accordance with another aspect of the disclosure, an electronic device for inferring position information of a user terminal is provided. The electronic device includes memory storing one or more computer programs and at least one processor communicatively coupled to the memory, wherein the one or more computer programs include computer-executable instructions that, when executed by the at least one processor individually or collectively, to identify signal data for one or more signal devices and data for an obstacle located within a certain distance from the user terminal, calculate first position prediction data, based on the signal data for the one or more signal devices, by using an artificial intelligence model for inferring position information, apply a weight value to the first position prediction data, based on the data for the obstacle, and determine the position information of the user terminal, based on the first position prediction data to which the weight value is applied.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include identifying a first data set comprising first signal data for a signal device collected at a first position by a user terminal, data for an obstacle located within a certain distance from the user terminal when collecting the first signal data, and second signal data for the signal device collected at a second position, generating a second data set by filtering out the first signal data from the first data set, based on the data for the obstacle, generating a third data set by generating augmented data for the first position and the signal device, based on the second signal data, and training an artificial intelligence model for inferring position information by using the third data set.

A program for causing a computer to perform a method of training an artificial intelligence model for inferring position information, according to an embodiment of the disclosure, may be recorded on a computer-readable recording medium.

A program for causing a computer to perform a method of inferring position information of a user terminal, according to an embodiment of the disclosure, may be recorded on a computer-readable recording medium.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating collecting training data of an artificial intelligence model for inferring position information, according to an embodiment of the disclosure;

FIG. 2 is a flowchart showing a method of training an artificial intelligence model for inferring position information, according to an embodiment of the disclosure;

FIG. 3 is a flowchart showing a method of inferring position information of a user terminal, according to an embodiment of the disclosure;

FIG. 4A is a diagram illustrating a first data set according to an embodiment of the disclosure;

FIG. 4B is a diagram illustrating a second data set from which data of the first data set is filtered, according to an embodiment of the disclosure;

FIG. 4C is a diagram illustrating a third data set including augmented data, according to an embodiment of the disclosure;

FIG. 5A is a graph showing filtering of signal data according to an embodiment of the disclosure;

FIG. 5B is a graph showing augmented data generation using a Gaussian process regression (GPR) algorithm according to an embodiment of the disclosure;

FIG. 6 is a flowchart showing a method, performed by an electronic device, of training an artificial intelligence model for inferring position information, according to an embodiment of the disclosure;

FIGS. 7A, 7B, and 7C are diagrams illustrating determining position information of a user terminal, according to various embodiments of the disclosure; and

FIG. 8 is a block diagram of an electronic device that trains an artificial intelligence model, an electronic device that collects data, and an electronic device that infers position information, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, the reference to “a component surface” includes reference to one or more of such surfaces.

Throughout the specification, the expression “a portion includes a certain element” means that the portion further includes other elements rather than excludes other elements unless otherwise stated.

Prior to detailed descriptions of the disclosure, the terms used in the present specification may be defined or understood as follows.

Throughout the disclosure, the expression “at least one of a, b or c” indicates only a, only b, only c, both a and b, both a and c, both b and c, all of a, b, and c, or variations thereof.

In the present specification, a ‘point’ may refer to a position within an arbitrary space. For example, position information of a user terminal may include information about a point at which the user terminal is predicted to be located among a plurality of points in a space. In the present specification, refpoint may represent a point, and similarly, a point may represent refpoint.

In the present specification, the terms ‘first,’ ‘second,’ or ‘third’ may be only used to distinguish elements from each other and may not imply the order of the elements.

In the present specification, ‘data collection’ may mean at least one of data measurement, data calculation, data obtainment, data identification, or data reception.

In the present specification, ‘augmented data’ may refer to arbitrarily generated data rather than data obtained by a measurement operation in a data collection environment. For example, ‘augmented data’ may be arbitrarily generated data for signals that are not actually transmitted or received between an electronic device and a signal device in any environment (e.g., position, time, or the like). In an embodiment of the disclosure, ‘augmented data’ may be generated by using an arbitrary method, algorithm, or model, based on signal data obtained as actual transmission and reception are performed between an electronic device and a signal device. For example, ‘augmented data’ may be generated based on other signal data by using a Gaussian process regression (GPR) algorithm, a received signal strength indicator (RSSI) path loss model, a synthetic minority oversampling technique (SMOTE) algorithm, an integrated oversampling (INOS) algorithm, a Gaussian noise addition method, or the like. For example, augmented data for a first position and a first signal device may be generated to replace signal data for the first signal device, which has been collected at the first position or may be collected at the first position.

In the present specification, ‘data related to an obstacle’ may refer to data for an obstacle located within a certain distance from the electronic device when the electronic device collects signal data for the signal device at an arbitrary position. For example, ‘obstacle’ may refer to an object that may affect signal transmission and reception between an electronic device and a signal device. Specifically, ‘obstacle’ is an object that may cause attenuation/amplification/interference/distortion of signals transmitted and received between an electronic device and a signal device, and may include a pedestrian, an electronic device of a pedestrian, or the like. Additionally, ‘certain distance’ may refer to a distance at which an obstacle may affect signal transmission and reception between an electronic device and a signal device and/or a distance at which an electronic device may identify an obstacle.

In an embodiment of the disclosure, ‘data for the obstacle’ may include data indicating strength of a signal received from the object. In this case, ‘certain distance’ may refer to a distance (e.g., a coverage) at which the signal may be received from the object. In an embodiment of the disclosure, ‘data for the obstacle” may include data indicating information received from the object. In this case, ‘certain distance’ may refer to a distance at which the signal may be received from the object. In an embodiment of the disclosure, ‘data for the obstacle’ may include data indicating an environment that is changed by the object. For example, ‘data for the obstacle’ may include physical values about an arbitrary environment that is changed by the object (e.g., a geo-magnetic scalar (or a change amount)). In this case, ‘certain distance’ may refer to a distance that may cause a change in environment where an electronic device is located. For example, ‘certain distance’ may refer to a distance that may cause a change in physical values indicating an environment of a region where an electronic device is located.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

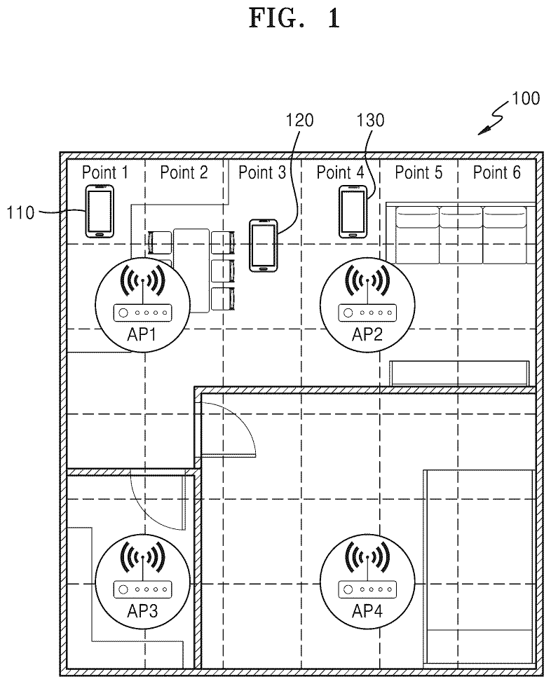

FIG. 1 is a diagram illustrating collecting training data of an artificial intelligence model for inferring position information according to an embodiment of the disclosure.

Referring to FIG. 1, a user terminal may transmit and receive signals to and from one or more signal devices fixedly located within a space 100. As the distance between the user terminal and the signal device increases, the strength of the signal is weakly measured, and as the distance between the user terminal and the signal device decreases, the strength of the signal is strongly measured. Accordingly, the position of the user terminal in the space 100 may be predicted based on the strength of the signal transmitted and received between the user terminal and the one or more signal devices within the arbitrary space 100.

Referring to FIG. 1, the space 100 may be divided into a plurality of points. For example, the space 100 may be divided into a plurality of small two-dimensional spaces (e.g., spaces of 1 m²), and the plurality of small spaces may respectively correspond to the points. The points in the space 100 may each be expressed by coordinates (e.g., point 1=(0,0)), but the disclosure is not limited thereto. Position information of the user terminal in the space 100 may correspond to one of the plurality of points.

In an embodiment of the disclosure, the distance between the user terminal and each of the signal devices may be calculated based on the strength of the signal transmitted and received between the user terminal and each of the signal devices, and the position of the user terminal in the space 100 may be predicted based on the calculated distance information to each of the signal devices. For example, when the distance from access point (AP) 1 is calculated to be 5 m, the distance from AP 2 is calculated to be 10 m, the distance from AP 3 is calculated to be 10 m, and the distance from AP 4 is calculated to be 18 m, based on the strength of the signal of each AP device which is measured by the user terminal, the user terminal may be respectively determined as being located at 5 m away from AP 1, 10 m away from AP 2, 10 m away from AP 3, and 18 m away from AP 4 in the space 100.

In an embodiment of the disclosure, the position of the user terminal (i.e., an inference target device) may be predicted, based on the strength of the signal received from each of the signal device, by using an artificial intelligence model trained to infer a position. For example, as the user terminal measures the strength of a wi-fi signal of each of the AP devices (e.g., AP 1, AP 2, AP 3, and AP 4 of FIG. 1) and inputs a strength value of each measured wi-fi signal to the artificial intelligence model, the position in the space 100 may be determined based on output position prediction data.

To train the artificial intelligence model that infers a position in a specific space, signal data for the corresponding space may be used as training data. Referring to FIG. 1, a user terminal 110 may be an electronic device (i.e., a data collection device) for collecting training data of the artificial intelligence model that infers a position in the space 100. The user terminal 110 may move in the space 100 and may collect training data at each collection cycle. The user terminal 110 may transmit the collected training data to the electronic device (e.g., one or more servers) that trains the artificial intelligence model. For example, the user terminal 110 may generate a data set by performing pre-processing on a plurality of collected training data and may transmit the generated data set to the electronic device that trains the artificial intelligence model.

In an embodiment of the disclosure, the user terminal 110 may collect signal data for the wi-fi signal of each of the AP devices for each collection cycle. For example, the user terminal 110 may measure the strength of the wi-fi signal from each of the AP devices. For example, the user terminal 110 may obtain distance information about a distance to each AP calculated based on the RTT of the wi-fi signal.

In an embodiment of the disclosure, the user terminal 110 may obtain position information in the space 100 for each collection cycle. For example, the user terminal 110 may obtain information indicating a point at which the user terminal 110 is located among the plurality of points in the space 100. For example, the user terminal 110 may receive a user input signal and determine a point corresponding to the user input signal as a position at the time of signal data collection.

The signals transmitted and received between the user terminal and the signal device may be affected by obstacles. For example, the signal strength when an obstacle is present between the user terminal and the signal device may be measured as a smaller value than the signal strength when no obstacle is present therebetween. For example, the signal strength between the user terminal and the signal device at the same distance may vary depending on the presence or absence of the obstacle. Accordingly, when the obstacle, such as a pedestrian is present during the process of collecting training data, low-quality data affected by the obstacle may be collected.

In an embodiment of the disclosure, when signal data for the wi-fi signal of each of the AP devices is collected, the user terminal 110 may collect short-range communication signal (e.g., Bluetooth signal) data of other user terminals 120 and 130 around the user terminal 110. For example, the user terminal 110 may identify Bluetooth signals of the other user terminals 120 and 130 around the user terminal 110 and may measure the strength of the Bluetooth signals. The wi-fi signal data collected when the Bluetooth signals of the other user terminals 120 and 130 are identified is low-quality data affected by surrounding obstacles, such as pedestrians and may have an adverse effect on the training of the artificial intelligence model.

Different user terminals may transmit distinguishable Bluetooth signals. Accordingly, when two other user terminals 120 and 130 are located around the user terminal 110, the user terminal 110 may identify two different Bluetooth signals. For example, the number of identified Bluetooth signals may indicate the number of obstacles located therearound. An expression that the strength of the Bluetooth signal is high may mean that an obstacle is located in a closer distance. In addition, an expression that the number of Bluetooth signals is large may mean that a larger number of obstacles are located therearound.

On the other hand, because the user terminal 110 collects data according to a collection cycle (or a measurement cycle) while moving through the space 100, the user terminal 110 may not collect data for all points. For example, when the user terminal 110 that measures the strength of the signal in the measurement cycle of 4 seconds passes through point 3 during one measurement cycle, the user terminal 110 may obtain signal data only for points 2 and 4 and may not obtain signal data for point 3.

In FIG. 1, one user terminal 110 collects data, but the disclosure is not limited thereto. For example, a plurality of data collection devices may collect training data for a single space at the same time or at different times. In the space 100 illustrated in FIG. 1, identifiers of points other than points 1 to 6 may be omitted. In addition, although FIG. 1 illustrates four AP devices as the signal devices, the disclosure is not limited thereto.

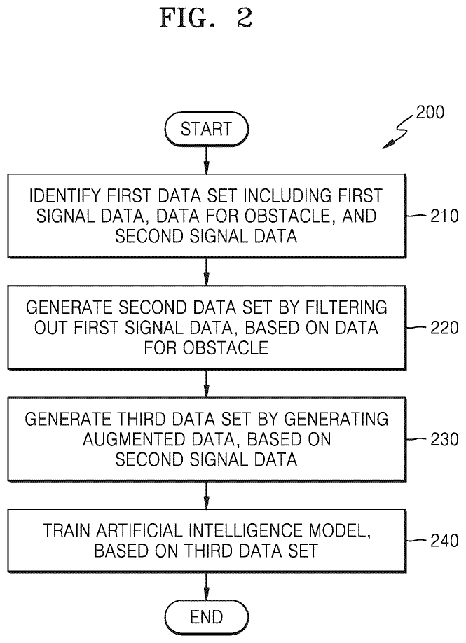

FIG. 2 is a flowchart showing a method of training an artificial intelligence model for inferring position information, according to an embodiment of the disclosure.

Referring to FIG. 2, a method 200, performed by an electronic device, of training an artificial intelligence model for inferring position information, according to an embodiment of the disclosure, may include operations 210 to 240. In an embodiment of the disclosure, operations 210 to 240 may be performed by at least one processor included in the electronic device. In one or more embodiments of the disclosure, the method 200 of training an artificial intelligence model for inferring position information is not limited to that illustrated in FIG. 2 and may further include operations not illustrated in FIG. 2.

In operation 210, the electronic device may identify a first data set including first signal data for a signal device collected at a first position by a user terminal (i.e., a data collection device), data for an obstacle located within a certain distance from the user terminal when the first signal data is collected (hereinafter, data for an obstacle associated with the first signal data), and second signal data for the signal device collected at a second position. In an embodiment of the disclosure, the electronic device may receive the first data set from the user terminal (e.g., 110 of FIG. 1). For example, the electronic device may directly receive the first data set from the user terminal. Alternatively, the electronic device may receive the first data set from the user terminal through another device. In an embodiment of the disclosure, the electronic device may generate the first data set by directly collecting signal data for one or more signal devices (e.g., by directly measuring wi-fi signals). In this case, the electronic device and the user terminal may be the same device.

In an embodiment of the disclosure, the signal device may be a wi-fi signal transceiver (e.g., an AP device), but the disclosure is not limited thereto. For example, the signal device may be a signal generation device provided in a space for inferring position information. The signal data for the signal device may include the strength of the signal transmitted by the signal device. In addition, the signal data for the signal device may include RTT-based distance information.

In an embodiment of the disclosure, the data for the obstacle associated with the first signal data may be data collected together when the first signal data is collected. For example, the data for the obstacle associated with the first signal data may be measured or obtained at the same time as the first signal data. Additionally or alternatively, when the collection cycle of the signal data is different from the collection cycle of the data for the obstacle, the data for the obstacle may be measured or obtained at a time point according to the collection cycle of the data for the obstacle immediately before or after the first signal data is collected.

In operation 220, the electronic device may generate a second data set by filtering out the first signal data from the first data set, based on the data for the obstacle. In an embodiment of the disclosure, the electronic device may identify a filtering reference value for the first signal data, based on the data for the obstacle associated with the first signal data. For example, the filtering reference value may be different or identical with respect to the position information, the signal device, and/or the data collection device for each signal data. The electronic device may remove the first signal data from the first data set, based on determining that the value of the first signal data (i.e., the value of the signal strength of the signal device measured at the first position) is less than or equal to the filtering reference value.

In operation 230, the electronic device may generate a third data set by generating augmented data for the first position and the signal device, based on the second signal data. In an embodiment of the disclosure, the electronic device may generate the augmented data for the signal device with respect to the first position (i.e., the augmented data for the first position and the signal device), based on the second signal data, by using a GPR algorithm.

In operation 240, the electronic device may train an artificial intelligence model by using the third data set. In an embodiment of the disclosure, the electronic device may train the artificial intelligence model by using the signal data and/or the augmented data for each signal device at each position. For example, the electronic device may train the artificial intelligence model by generating a fingerprint that maps signal data of each of the plurality of signal devices with respect to each position (i.e., point) in the space.

In an embodiment of the disclosure, the electronic device may perform supervised learning on the artificial intelligence model by using signal data for each signal device as input data and position information for the input data as ground truth data, but the learning method is not limited to the supervised learning. For example, the position information corresponding to the ground truth data may have been labeled by a training data collector. As signal data (i.e., signal strength) for each signal device obtained by the inference target device (e.g., the user terminal) is input, the artificial intelligence model may be trained to predict the position of the inference target device in the space.

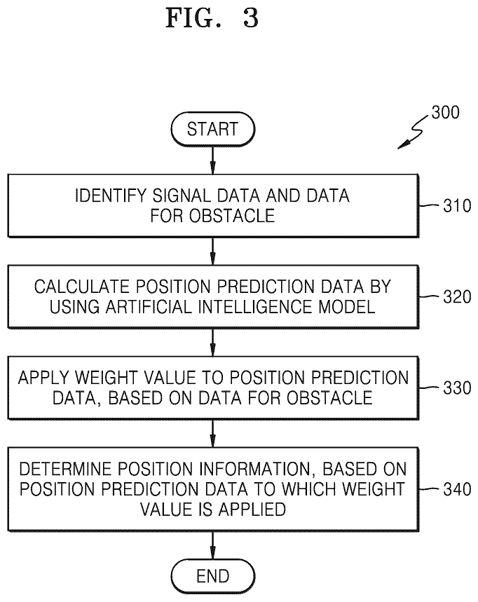

FIG. 3 is a flowchart showing a method of inferring position information of a user terminal according to an embodiment of the disclosure.

Referring to FIG. 3, a method 300, performed by an electronic device, of inferring position information of a user terminal, according to an embodiment of the disclosure, may include operations 310 to 340. In an embodiment of the disclosure, operations 310 to 340 may be performed by at least one processor included in the electronic device. In one or more embodiments of the disclosure, the method 300, performed by the electronic device, of inferring position information of the user terminal is not limited to that illustrated in FIG. 3 and may further include operations not illustrated in FIG. 3. The electronic device that performs the method 300 of FIG. 3 may be different from or identical to the electronic device that performs the method 200 of FIG. 2.

In operation 310, the electronic device may identify signal data for one or more signal devices and data for an obstacle located within a certain distance from the user terminal (i.e., the inference target device). In an embodiment of the disclosure, the signal data for the one or more signal devices may include values of signal strengths of the one or more signal devices. In an embodiment of the disclosure, the data for the obstacle may include at least one of a value of a short-range communication (e.g., Bluetooth) signal strength of another user terminal or a geo-magnetic change amount due to the obstacle.

In operation 310, the signal data for the one or more signal devices and the signal data for the obstacle may be data measured (or obtained) at the same time point. For example, the data for the obstacle may include data for an obstacle located around the user terminal when the signal data for the one or more signal devices are measured.

In an embodiment of the disclosure, the electronic device that performs the method 300 may be the user terminal subjected to position information inference. For example, the electronic device (i.e., the user terminal) may measure the strengths of the signals from the one or more signal devices and the strength of the Bluetooth signal from another user terminal. For example, the electronic device may receive signal data for the one or more signal devices from the signal device. For example, the electronic device may receive the data for the obstacle from the obstacle.

In an embodiment of the disclosure, the electronic device that performs the method 300 may be a device that is different from the user terminal subjected to position information inference. In this case, the electronic device may receive the signal data for the one or more signal devices and the data for the obstacle from the user terminal subjected to position information inference.

In operation 320, the electronic device may calculate first position prediction data, based on the signal data for the one or more signal devices, by using the artificial intelligence model for inferring position information. In an embodiment of the disclosure, the artificial intelligence model for inferring position information may be a model trained by the method 200 of FIG. 2.

The first position prediction data calculated in operation 320 may include data related to a probability that the user terminal is to be located at each point. Additionally or alternatively, the first position prediction data may include one or more points, at which the user terminal is predicted to be located, together, with a predicted rank. For example, the first position prediction data may include the first-rank point 1 and the second-rank point 7, at which the user terminal is predicted to be located.

In operation 330, the electronic device may apply a weight value to the first position prediction data, based on the data for the obstacle. In an embodiment of the disclosure, the weight value applied to the first position prediction data may be determined based on at least one of the number of obstacles or the value of the data for the obstacle. For example, when the strength of the Bluetooth signal of another user terminal is measured to be strong, the electronic device may apply a low weight value to the first position prediction data calculated based on the low-quality signal data. For example, when a plurality of Bluetooth signals are identified, the electronic device may apply a low weight value to the first position prediction data calculated based on the low-quality signal data.

In operation 340, the electronic device may determine position information of the user terminal (i.e., the inference target device) (e.g., the electronic device that performs the method 300), based on the first position prediction data to which the weight value is applied.

In an embodiment of the disclosure, the electronic device may identify second position prediction data. For example, the electronic device may identify the second position prediction data for the user terminal calculated by using data, method, algorithm, or model that is different from that of the first position prediction data. The electronic device may apply a weight value to the second position prediction data, based on the data for the obstacle. In this case, the electronic device may determine position information of the user terminal, based on the first position prediction data to which the weight value is applied and the second position prediction data to which the weight value is applied.

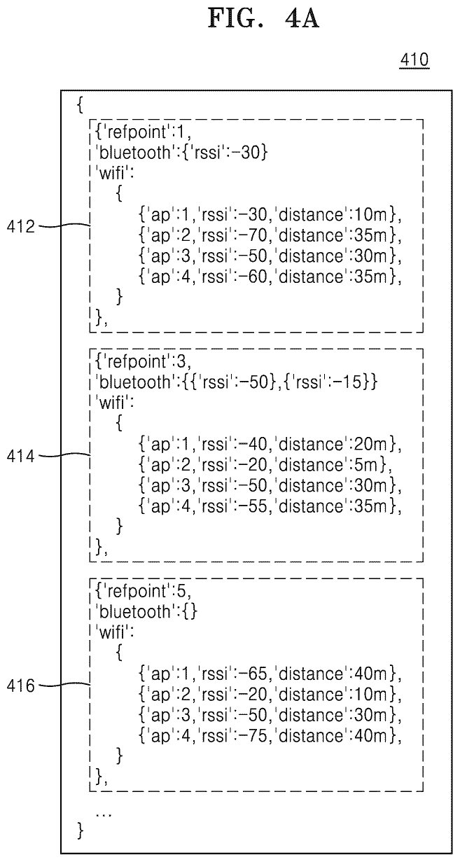

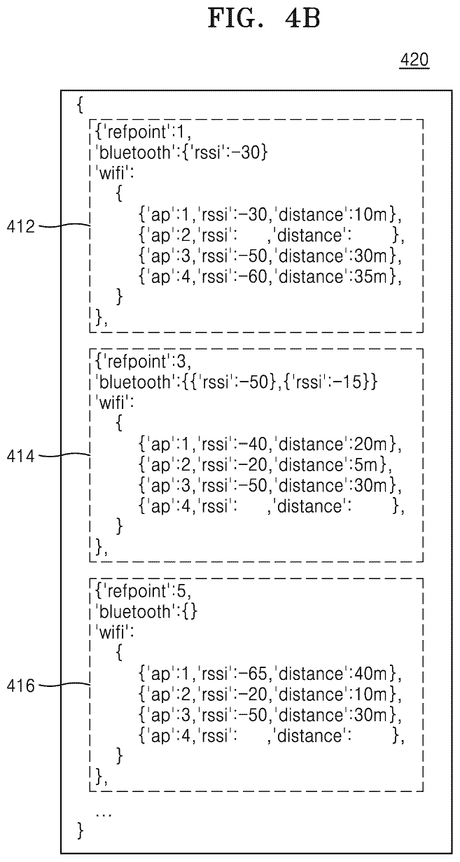

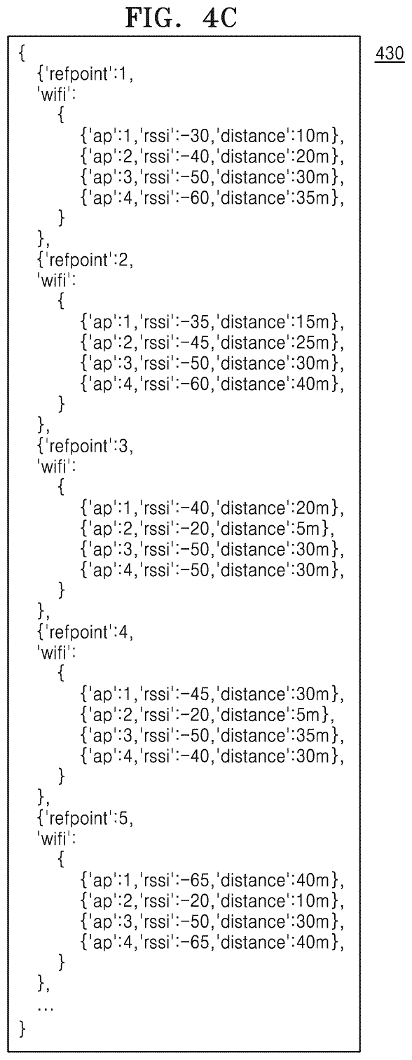

FIG. 4A is a diagram illustrating an example of a first data set according to an embodiment of the disclosure. FIG. 4B is a diagram illustrating an example of a second data set from which data of the first data set is filtered, according to an embodiment of the disclosure. FIG. 4C is a diagram illustrating an example of a third data set including augmented data, according to an embodiment of the disclosure.

A data set may include one or more data groups. The data groups may each include data measured or obtained during each collection cycle. For example, data included in one data group may be measured or obtained at the same time point.

Referring to FIG. 4A, the data groups 412, 414, and 416 may each include information (‘refpoint’) indicating a position at which the data group is measured or obtained. The data groups may each include signal data for each signal device (e.g., an AP device). For example, the signal data may include an identifier (‘ap’) of the signal device. The signal data may include a value of signal strength (‘rssi’). The signal data may include distance information (‘distance’) between the collection device and each signal device when the signal data is collected. For example, the distance information (‘distance’) may be a value calculated from the RTT of the signal.

The data groups 412, 414, and 416 may each include data (‘bluetooth’) for the obstacle. The data for the obstacle may be measured or obtained together when the signal data of the data groups 412, 414, and 416 are collected. In an embodiment of the disclosure, the data for the obstacle may include Bluetooth signal data. For example, the data for the obstacle may include Bluetooth signal data of another user terminal located within a Bluetooth signal transmission and reception range from the data collection device. For example, when a pedestrian is present around the data collection device when signal data is measured or obtained, the strength of a Bluetooth signal received from a user terminal of the pedestrian may be included in the data set as the data for the obstacle.

In an embodiment of the disclosure, the data for the obstacle may include a geo-magnetic change amount due to the obstacle. For example, when another electronic device is present in close proximity to a data collection device that measures or obtains a geo-magnetic scalar value, the geo-magnetic scalar value may change rapidly. For example, when another electronic device is present in close proximity, a geo-magnetic change amount may increase. In this case, the data for the obstacle may include data for an electronic device located within a range that may affect a geo-magnetic scalar of a region where the data collection device is located. For example, the geo-magnetic change amount due to the obstacle may be included in the data set as the data for the obstacle.

In a first data set 410, based on data for an obstacle in an arbitrary data group, the electronic device may filter signal data for an arbitrary signal device included in the corresponding data group. In an embodiment of the disclosure, the electronic device may identify a filtering reference value for each data group, based on the data for the obstacle in each data group, and may remove, from each data group, signal data having a value less than or equal to the filtering reference value.

In an embodiment of the disclosure, the filtering reference value may be determined based on at least one of the number of obstacles or the value of the data for the obstacle. The number of obstacles may correspond to the number of data for the obstacle. For example, as the number of data for the obstacle increases, a higher reference value may be determined. Alternatively, as the number of data for the obstacle decreases, a higher reference value may be determined. For example, as the value of the data for the obstacle increases, a higher reference value may be determined. Alternatively, as the value of the data for the obstacle decreases, a higher reference value may be determined.

Referring to FIG. 4A, the electronic device may determine a filtering reference value for each of the data group 412, 414, and 416, based on the Bluetooth signal data of each of the data groups 412, 414, and 416. For example, the reference value of the data group 412 may be determined to be −65 dB, based on the assumption that the number of Bluetooth signal data of the data group 412 is 1 and the strength of the Bluetooth signal is −30 dB. In addition, the electronic device may determine the reference value of the data group 414 to be −55 dB, based on the assumption that the number of Bluetooth signal data of the data group 414 is 2 and the strengths of the Bluetooth signals are respectively −50 dB and −15 dB. In addition, the electronic device may determine the reference value of the data group 416 to be −70 dB, based on the assumption that the number of Bluetooth signal data of the data group 416 is 0.

Referring to FIG. 4B, the electronic device may generate a second data set 420 by removing, from the first data set 410, signal data determined to be less than or equal to the filtering reference value among a plurality of signal data included in each of the data groups 412, 414, and 416. For example, the electronic device may remove AP 2 signal data less than or equal to −50 dB from the data group 412. In addition, the electronic device may remove AP 4 signal data less than or equal to −55 dB from the data group 414. In addition, the electronic device may remove AP 4 signal data less than or equal to −70 dB from the data group 416. In contrast, the electronic device may not remove signal data included in the data group 416, which is high-quality data that is not affected by surrounding pedestrians, or the like, based on the assumption that the number of Bluetooth signal data of the data group 416 is 0.

The electronic device may generate a third data set 430 by performing data augmentation. In an embodiment of the disclosure, the electronic device may generate augmented data for a position from which the signal data is removed, based on signal data for the signal device with respect to another position (i.e., another refpoint), by using a GPR algorithm. Referring to FIG. 4C, the electronic device may generate augmented data that supplements/replaces signal data removed from each data group, based on signal data included in other data groups, by using a GPR algorithm.

Referring to FIGS. 4B and 4C, when signal data for AP 2 is removed from the data group 412, the electronic device may generate augmented data for AP 2 of the data group 412, based on the signal data for AP 2 of the other data groups 414 and 416, by using a GPR algorithm. Similarly, when signal data for AP 4 is removed from the data groups 414 and 416, the electronic device may generate augmented data for AP 4 of the data groups 414 and 416, based on the signal data for AP 4 of the other data group 412, by using a GPR algorithm.

Because the data collection device collects data according to the collection cycle while moving, data may not be collected at some positions (i.e., some refpoints). Referring to FIG. 4A, signal data and data for the obstacle may not be collected at refpoints 2 and 4. Accordingly, the electronic device may generate augmented data for each signal device with respect to refpoints 2 and 4, which are positions at which data are not collected (i.e., positions independent of the signal data included in the first data set 410 and/or the second data set 420).

For example, the electronic device may generate augmented data for positions at which data are not collected (i.e., positions independent of the signal data included in the first dataset 410), based on signal data for other positions, with respect to each signal device by using a GPR algorithm. Referring to FIGS. 4B and 4C, the electronic device may generate augmented data for AP 1 for refpoint 2, which is a position at which data is not collected, based on signal data for AP 1 of the data group 412 (i.e., AP 1 signal data for refpoint 1), signal data for AP 1 of the data group 414 (i.e., AP 1 signal data for refpoint 3), and signal data for AP 1 of the data group 416 (i.e., AP 1 signal data for refpoint 5), by using a GPR algorithm.

The data set structures illustrated in FIGS. 4A to 4C is an example of the data set for training the artificial intelligence model, but the disclosure is not limited thereto. For example, the data set may further include information other than the illustrated information (e.g., information about the collection device). For example, pieces of information may be classified or aligned into different types of structures.

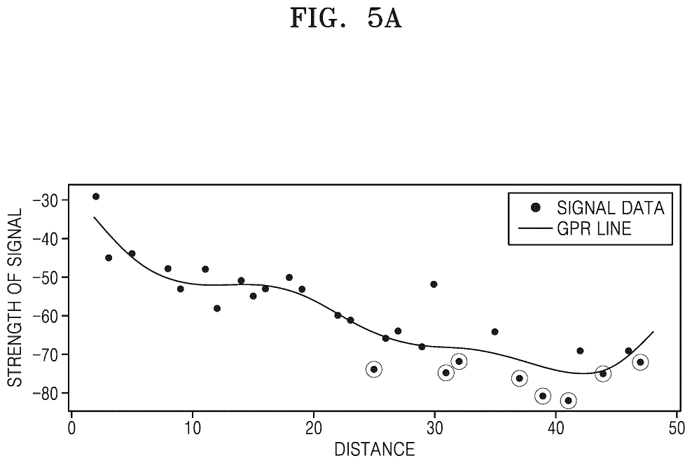

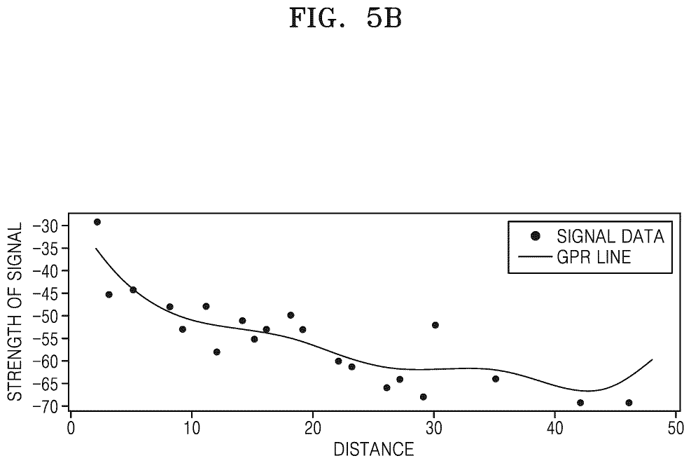

FIG. 5A is a graph showing filtering of signal data, according to an embodiment of the disclosure. FIG. 5B is a graph showing augmented data generation using a GPR algorithm, according to an embodiment of the disclosure.

The graphs shown in FIGS. 5A and 5B are graphs showing a plurality of signal data for an arbitrary electronic device. In the graphs shown in FIGS. 5A and 5B, the x-axis may represent distance information (e.g., a distance value, a distance index, a position index, or the like) and the y-axis may represent a strength value of a wi-fi signal (e.g., a dB value). Due to characteristics of the wi-fi signal, as the distance increases, the strength of the wi-fi signal may decrease logarithmically. However, in real environments, due to interference from external factors, the graph of the strength of the wi-fi signal with respect to the distance may not appear as a perfect logarithmic function graph.

In an embodiment of the disclosure, the electronic device may process data for each signal device in order for data augmentation. For example, the electronic device may perform data augmentation for a corresponding signal device by using signal data for an arbitrary signal device in each of the plurality of data groups (e.g., 412, 414, and 414 of FIG. 4B) included in the data set (e.g., 420 of FIG. 4B).

FIG. 5A shows a graph of signal data for an arbitrary signal device (e.g., AP 1). Specifically, FIG. 5A shows a graph reflecting the value of the signal strength (‘rssi’) and distance information (‘distance’) of an arbitrary signal device included in the data set (e.g., 410 of FIG. 4A) before data-based filtering is performed on an obstacle. The plurality of signal data discretely shown in the graph of FIG. 5A may be data collected by the data collection device.

At least some of the plurality of signal data for any signal device may be removed by data-based filtering on the obstacle. For example, among the plurality of signal data for the arbitrary signal device, signal data whose signal strength is lower than a reference value (e.g., −70 dB) determined based on the data for the obstacle may be removed. The reference values of the plurality of signal data for the arbitrary signal device may be different from each other, partially different from each other, or equal to each other. Referring to FIG. 5A, highlighted (circled) signal data among the plurality of signal data shown on the graph may represent signal data removed by data-based filtering on the obstacle.

The graph of FIG. 5B is a graph from which the circled signal data in the graph of FIG. 5A is removed. For example, FIG. 5A shows a graph reflecting the signal strength (‘rssi’) value and distance information (‘distance’) of an arbitrary signal device included in the data set (e.g., 420 of FIG. 4B) after data-based filtering is performed on the obstacle.

The electronic device may use a GPR model to generate augmented data for a corresponding signal device, based on signal data for an arbitrary signal device included in the data set after data-based filtering is performed on the obstacle. For example, the electronic device may generate a GPR-based function indicating signal strength with respect to a distance, based on the plurality of signal data shown in the graph of FIG. 5B. A GPR line shown in the graph of FIG. 5B represents the GPR-based function.

The electronic device may generate augmented data for each position at which signal data is not present for an arbitrary signal device. For example, the signal strength value of the GPR line at the x-axis point corresponding to each position of the graph of FIG. 5B may be generated as augmented data for the corresponding position. The position at which signal data is not present may include a position at which signal data is filtered and/or a position at which signal data is not collected.

The electronic device may generate augmented data not only for the position at which signal data is not present, but also for the position at which signal data is present. In an embodiment of the disclosure, the electronic device may generate augmented data for the corresponding position, based on signal data for the corresponding position and/or signal data for other positions, even with respect to the position at which signal data is present. For example, the electronic device may generate augmented data for point 30 on the x-axis at which signal data of −50 dB is present. In this case, the electronic device may determine −60 dB, which is the value of the GPR line at point 30 on the x-axis, as augmented data.

In an embodiment of the disclosure, the electronic device may use a GPR algorithm to generate augmented data, based on at least some of the plurality of signal data for the arbitrary signal device. In this case, as the data used to generate the GPR line among the plurality of signal data changes, the GPR line may change. In an embodiment of the disclosure, even when the same signal data is used, the GPR line may change according to a setting value of the GPR algorithm (e.g., a parameter value or an option value). For example, the electronic device may generate a plurality of GPR lines, and thus, a plurality of pieces of augmented data may be obtained for one x-axis point.

Referring to the GPR lines of FIGS. 5A and 5B, the logarithmic function trend may be more evident in the GPR line after filtering than the GPR line before filtering. For example, the augmented data generated by using the GPR algorithm after filtering may be better quality data.

FIGS. 5A and 5B are graphs showing filtering and augmenting training data of an artificial intelligence model in an embodiment of the disclosure, which may not be generated and output as the electronic device performs the method according to various embodiments of the disclosure.

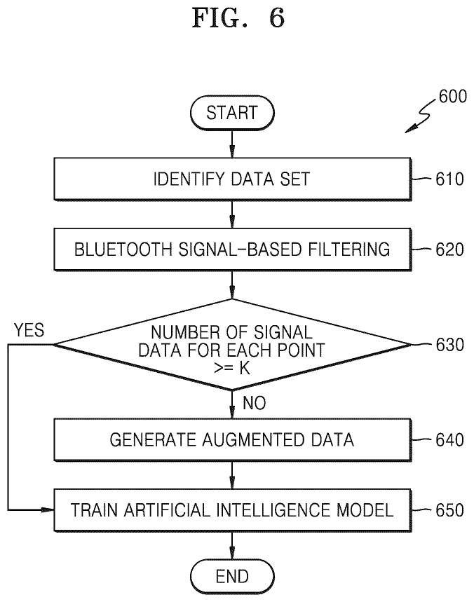

FIG. 6 is a flowchart showing a method, performed by an electronic device, of training an artificial intelligence model for inferring position information, according to an embodiment of the disclosure.

Referring to FIG. 6, a method 600, performed by an electronic device, of training an artificial intelligence model for inferring position information, according to an embodiment of the disclosure, may include operations 610 to 650. In an embodiment of the disclosure, operations 610 to 650 may be performed by at least one processor included in the electronic device. In one or more embodiments of the disclosure, the method 600 of training an artificial intelligence model for inferring position information is not limited to that illustrated in FIG. 6 and may further include operations not illustrated in FIG. 6. Hereinafter, in explaining FIG. 6, descriptions redundant with those provided above with reference to FIG. 2 may be omitted.

In operation 610, the electronic device may identify a first data set.

In operation 620, the electronic device may perform Bluetooth signal-based filtering on the first data set. In an embodiment of the disclosure, the electronic device may generate a second data set by filtering wi-fi signal data of an AP device, based on a Bluetooth signal in the first data set.

In operation 630, the electronic device may determine whether the number of signal data for each point is greater than or equal to a threshold value K (where K is a natural number). In an embodiment of the disclosure, the electronic device may determine whether the number of signal data for each of a plurality of positions (i.e., a plurality of points) is greater than or equal to the threshold value. In an embodiment of the disclosure, the threshold value may be determined based on the number of training data required for the performance (e.g., accuracy, sensitivity, precision, or the like) of the artificial intelligence model to satisfy an arbitrary criterion. For example, the threshold value may be a predefined value (e.g., 10).

In operation 650, in response to determining that the number of signal data for each point is greater than or equal to the threshold value, the electronic device may train the artificial intelligence model by using the signal data for each point.

In contrast, in operation 640, in response to determining that the number of signal data for at least one point (e.g., the number of data groups) is less than K, the electronic device may generate augmented data for each signal device with respect to the point at which the number of signal data is insufficient. In an embodiment of the disclosure, the electronic device may generate augmented data so that the number of training data (signal data and augmented data) for each point is K or more.

In operation 650, the electronic device may train the artificial intelligence model by using the training data for each point. For example, the electronic device may train the artificial intelligence model by using signal data and/or augmented data of each of the plurality of signal devices for each point.

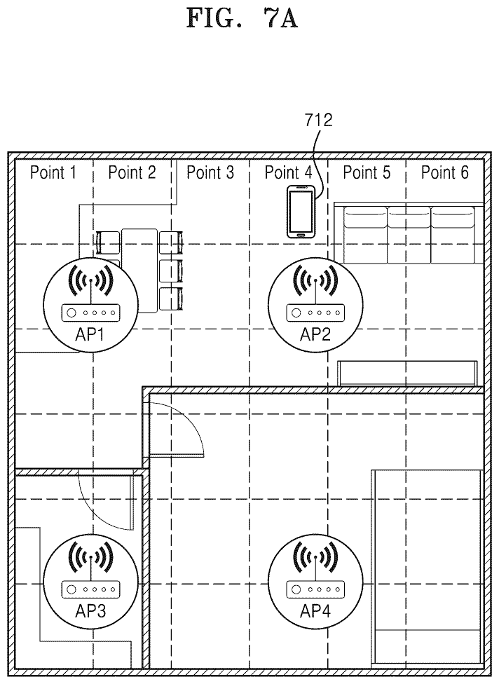

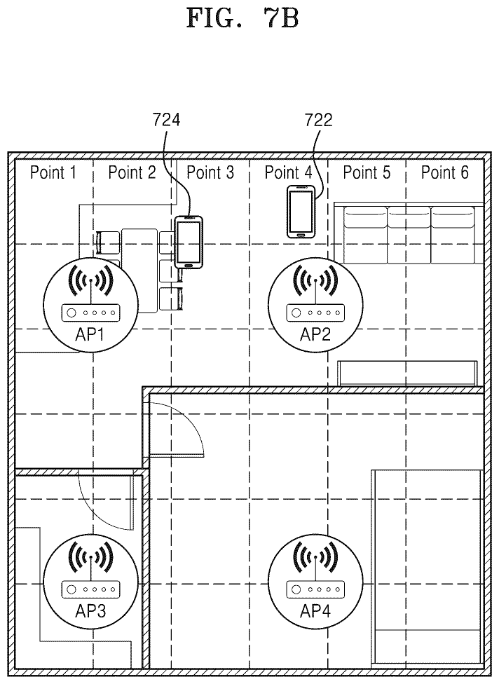

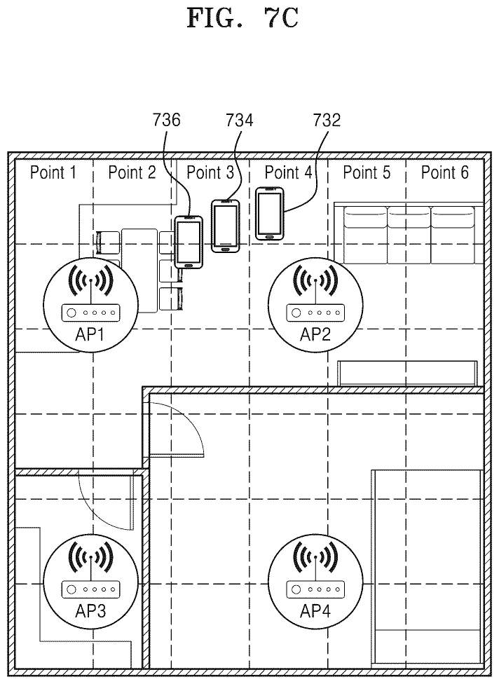

FIGS. 7A, 7B, and 7C are diagrams illustrating determining position information of a user terminal by using an artificial intelligence model, according to various embodiments of the disclosure.

In an embodiment of the disclosure, to infer position information of user terminals 712, 722, and 732, the user terminals 712, 722, and 732 may identify signal data for one or more signal devices and data for obstacles located at a certain distance from the user terminals 712, 722, and 732. For example, referring to FIGS. 7A to 7C, the user terminals 712, 722, and 732 may measure the strength (rssi) of wi-fi signals of AP 1 to AP 4. In addition, the user terminals 712, 722, and 732 may measure the strength of Bluetooth signals of other user terminals 724, 734, and 736. In this case, the certain distance may represent the distance at which the Bluetooth signals may be transmitted and received.

In an embodiment of the disclosure, the user terminals 712, 722, and 732 may calculate first position prediction data of the user terminals 712, 722, and 732, based on the identified signal data for one or more signal devices, by using the artificial intelligence model for inferring position information trained with training data filtered based on the data for the obstacles. For example, the user terminals 712, 722, and 732 may obtain the first position prediction data output by inputting the strength values of the wi-fi signals of AP 1 to AP 4 to the artificial intelligence model trained with training data filtered based on the Bluetooth signals.

In an embodiment of the disclosure, the artificial intelligence model may output the first position prediction data including a probability (or a score corresponding to a probability) that the user terminals 712, 722, and 732 is to be located at an arbitrary point among the plurality of points in the space. For example, the artificial intelligence model may output the first position prediction data including a probability (or a score) or an identifier of at least one point. In an embodiment of the disclosure, the artificial intelligence model may output the first position prediction data including an identifier and a predicted rank of at least one of the plurality of points. At least some points may include points whose predicted ranks correspond to the first rank to a specific rank. For example, the first position prediction data may be output in a structure, such as ‘[(first rank, point1), (second rank, point9), (third rank, point5), (fourth rank, point3), or (fifth rank, point5)]’. The predicted rank of each point may be determined based on the score of each point. For example, the predicted rank of point 1, which is the point with the highest probability (i.e., score) at which the user terminals 712, 722, and 732 are to be located, may be determined as the first rank, and the predicted rank of point 7, which is the point with the second highest probability, may be determined as the second rank.

In an embodiment of the disclosure, based on the data for the obstacles, the user terminals 712, 722, and 732 may apply a weight value to the first position prediction data calculated based on the artificial intelligence model. Furthermore, the user terminals 712, 722, and 732 may identify second position prediction data. The user terminals 712, 722, and 732 may apply a weight value to second position prediction data, based on the data for the obstacles.

The second position prediction data may be data calculated based on a different data, method, algorithm, and/or model than the first position prediction data. For example, when the first position prediction data is data output from the artificial intelligence model trained by using training data filtered based on the Bluetooth signals, the second position prediction data may be data output from the artificial intelligence model trained by using training data filtered based on the geo-magnetic change amount.

In an embodiment of the disclosure, the second position prediction data may include a probability (or a score) that the user terminals 712, 722, and 732 are to be located in at least one of the plurality of points. For example, the second position prediction data may include a probability (or score) or an identifier of the at least one point. In an embodiment of the disclosure, the second position prediction data may output the first position prediction data including an identifier and a predicted rank of at least one of the plurality of points. The at least one point may include points whose predicted ranks correspond to the first rank to a specific rank.

In an embodiment of the disclosure, the user terminals 712, 722, and 732 may determine position information of the user terminals 712, 722, and 732, based on the first position prediction data to which the weight value is applied. For example, the user terminals 712, 722, and 732 may determine the position information of the user terminals 712, 722, and 732 by using Equation 1 below.

$$predict\_refpoint = \frac{{\sum }_{n = 1}^{k} {w}_{n} * {refpoint}_{n}}{{\sum }_{n = 1}^{k} {w}_{n}} \qquad Equation 1$$

In Equation 1 above, refpointₙ represents the coordinate value of the point whose predicted rank is an n^{th} rank, k represents the number of prediction points to be considered in determining the position of the user terminal, and wₙ represents a weight value to be applied to refpointₙ. The weight value wₙ may be an arbitrary value determined based on the Bluetooth signal data when measuring the signal data. The user terminals 712, 722, and 732 may determine a point close to a value of predict_refpoint calculated by Equation 1 as the positions of the user terminals 712, 722, and 732.

The user terminals 712, 722, and 732 may determine position information of the user terminals 712, 722, and 732, based on the first position prediction data and the second position prediction data to which the weight values are applied. For example, the user terminals 712, 722, and 732 may determine the position information of the user terminals 712, 722, and 732 by using Equation 2 below.

$$Equation 2$$

$$predict\_refpoint = \frac{{\sum }_{n = 1}^{m} {w}_{n} * f . {refpoint}_{n} + {\sum }_{n = 1}^{k} {w}_{n + m} * s . {refpoint}_{n}}{{\sum }_{n = 1}^{k + m} {w}_{n}}$$

In Equation 2 above, f.refpointₙ represents the coordinate value of the point whose predicted rank is an n^{th} rank in the first position prediction data, s.refpointₙ represents the coordinate value of the point whose predicted rank is an n^{th} rank in the second position prediction data, wₙ represents the weight value to be applied to the point whose rank is an n^{th} rank in the first position prediction data, and wₙ₊ₘ may represent the weight value to be applied to the point whose rank is an n^{th} rank in the second position prediction data. m may represent the number of prediction points to be considered for determining the position information of the user terminal from the first position prediction data, and k may represent the number of prediction points to be considered for determining the position information of the user terminal from the second position prediction data. The user terminals 712, 722, and 732 may determine a point corresponding to a value of predict_refpoint calculated by Equation 2 or a point close thereto as the positions of the user terminals 712, 722, and 732.

Referring to FIG. 7A, when no Bluetooth signal is received by the user terminal 712, that is, when no other user terminal is present around the user terminal 712, the user terminal 712 may determine position information based on Equation 3 below.

$$Equation 3$$

$$predict\_refpoint = \frac{\begin{matrix}0.6 * f . {refpoint}_{1} + 0 \text{.3} * \\ f . {refpoint}_{2} + 0.1 * s . refpoin {t}_{1}\end{matrix}}{0.6 + 0.3 + 0.1}$$

In Equation 3 above, f.refpoint₁ represents a first-rank predicted point according to the first position prediction data, and f.refpoint₂ represents a second-rank predicted point according to the first position prediction data. In addition, s.refpoint₁ represents a first-rank predicted point according to the second position prediction data. The user terminal 712 may determine a point close to a value of predict_refpoint calculated by Equation 3 as the position of the user terminal 712. For example, as illustrated in FIG. 7A, when no Bluetooth signal is received from another user terminal around the user terminal 712, the user terminal 712 may determine position information by applying a higher weight value to the first position prediction data than to the second position prediction data.

Referring to FIG. 7B, when one Bluetooth signal is received by the user terminal 722, that is, when one other user terminal 724 is present around the user terminal 722, the user terminal 722 may determine position information based on Equation 4 below.

$$Equation 4$$

$$predict\_refpoint = \frac{0.4 * f . {refpaint}_{1} + 0.2 * f . {refpoint}_{2} + 0.4 * s . {refpoint}_{1}}{0.4 + 0 \text{.2} + 0.4}$$

In Equation 4 above, f.refpoint₁ represents a first-rank predicted point according to the first position prediction data, and f.refpoint₂ represents a second-rank predicted point according to the first position prediction data. In addition, s.refpoint₁ represents a first-rank predicted point according to the second position prediction data. The user terminal 722 may determine a point close to a value of predict_refpoint calculated by Equation 4 as the position of the user terminal 722. Compared to FIG. 7A, the user terminal 722 may lower the weight value of the first position prediction data calculated based on the signal data that has been interfered with by an obstacle, and may increase the weight value of the second position prediction data.

Referring to FIG. 7C, when two Bluetooth signals are received by the user terminal 732, that is, when two other user terminals 734 and 736 are present around the user terminal 732, the user terminal 732 may determine position information based on Equation 5 below.

$$Equation 5$$

$$predict\_refpoint = \frac{0.2 * f . {refpaint}_{1} + 0.6 * s . {refpoint}_{1} + 0.2 * s . {refpoint}_{2}}{0.2 + 0.6 + 0.2}$$

In Equation 5 above, f.refpoint₁ represents a first-rank predicted point according to the first position prediction data. s.refpoint₁ represents a first-rank predicted point according to the second position prediction data and s.refpoint₂ represents a second-rank predicted point according to the second position prediction data. The user terminal 732 may determine a point close to a value of predict_refpoint calculated by Equation 5 as the position of the user terminal 732. Compared to FIGS. 7A and 7B, the user terminal 732 may lower the weight value of the first position prediction data calculated based on the signal data that has been greatly interfered with by an obstacle, and may increase the weight value of the second position prediction data.

f.refpont₁, f.refpoint₂, s.refpont₁, and s.refpoint₂ may be (x,y) coordinate values corresponding to the respective points in the space. Accordingly, ‘predict_refpoint’ calculated by Equations (3) to (5) above may also be expressed as (x, y) values. The user terminals 712, 722, and 732 may determine a point corresponding to a value of ‘predict_refpoint’ as the positions of the user terminals 712, 722, and 732. For example, when the value of ‘predict_refpoint’ is calculated as (0.23, 2.89), a point (0,3) (e.g., point 4), which is the rounded coordinate of (0.23, 2.89), may be determined as the position of the user terminal.

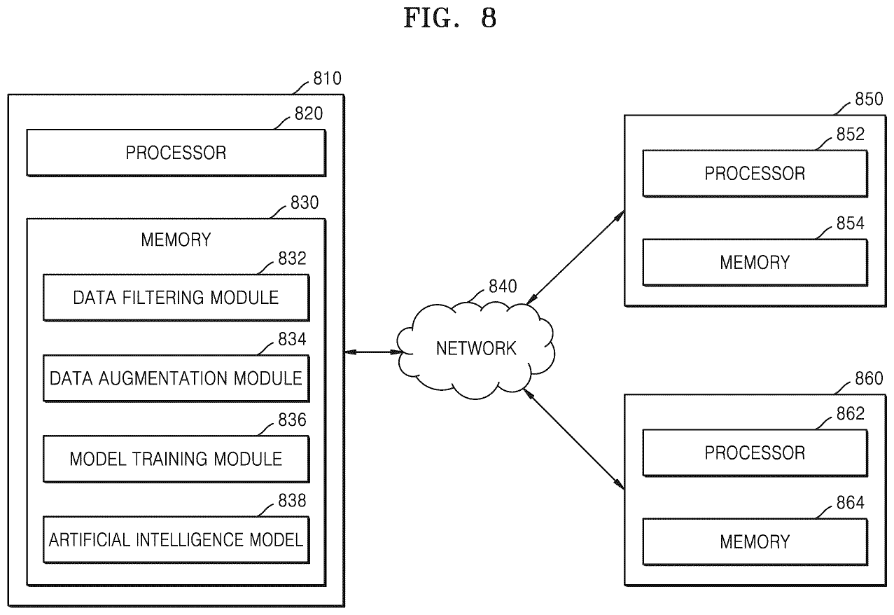

FIG. 8 is a block diagram of an electronic device for training an artificial intelligence model, an electronic device for collecting data, and an electronic device for inferring position information, according to an embodiment of the disclosure.

An electronic device 810 of FIG. 8 may be any computing device that trains an artificial intelligence model. The electronic device 810 may include one or more server devices. The electronic device 810 may include at least one processor 820 and memory 830. An electronic device 850 of FIG. 8 may be any computing device that collects training data for an artificial intelligence model. The electronic device 850 may include at least one processor 852 and memory 854. An electronic device 860 of FIG. 8 may be any computing device that infers position information by using an artificial intelligence model. The electronic device 860 may include at least one processor 862 and memory 864.

Each of the electronic devices 850 and 860 may be a user terminal, such as a smartphone, a tablet personal computer (PC), a mobile phone, a smart watch, a desktop computer, a laptop computer, a notebook, smart glasses, a navigation device, a wearable device, an augmented reality (AR) device, a virtual reality (VR) device, or a digital signal transceiver.

The processors 820, 852, and 862 may be electrically connected to components included in the electronic devices 810, 850, and 860, respectively, and may perform operations or data processing related to control and/or communication of the components included in the electronic devices 810, 850, and 860, respectively. According to an embodiment of the disclosure, the processors 820, 852, and 862 may load a request, a command or, data received from at least one of the other components into the memories 830, 854, and 864, may process the request, the command, and the data, and may store resulting data in the memories 830, 854, and 864, respectively. According to one or more embodiments of the disclosure, each of the processors 820, 852, and 862 may include at least one of a general-purpose processor, such as a central processing unit (CPU), an application processor (AP), or a digital signal processor (DSP), a dedicated graphics processor, such as a graphic processing unit (GPU) or a vision processing unit (VPU), or a dedicated artificial intelligence processor, such as a neural processing unit (NPU).

The processors 820, 852, and 862 may be controlled to process input data according to predefined operation rules or artificial intelligence models stored in the memory. Alternatively, when the processors 820, 852, and 862 are dedicated artificial intelligence processors, the dedicated artificial intelligence processors may be designed with a hardware structure specialized for processing a specific artificial intelligence model.

The predefined operation rules or the artificial intelligence models are made through learning. The expression “made through learning” may mean that the predefined operation rules or the artificial intelligence models configured to perform desired characteristics (or purpose) are made in such a manner that a basic artificial intelligence model is trained by using a large number of training data by a learning algorithm. The learning may be accomplished in a device itself that performs artificial intelligence according to the disclosure, or may be accomplished through a separate server and/or system. Examples of the learning algorithm include supervised learning, unsupervised learning, semi-supervised learning, or reinforcement learning, but the disclosure is not limited to the examples described above.

The memories 830, 854, and 864 may be electrically connected to the processors 820, 852, and 862, respectively, and may store one or more modules, at least one training model, programs, commands, or data related to the operations of the components included in the electronic devices 810, 850, and 860, respectively. For example, the memories 830, 854, and 864 may store one or more modules, training models, programs, instructions, or data for processing and controlling the processors 820, 852, and 862, respectively. Each of the memories 830, 854, and 864 may include at least one type of storage medium selected from flash memory-type memory, hard disk-type memory, multimedia card micro-type memory, card-type memory (e.g., secure digital (SD) or extreme digital (XD) memory), random access memory (RAM), static random access memory (SRAM), read-only memory (ROM), electrically erasable programmable read-only memory (EEPROM), programmable read-only memory (PROM), magnetic memory, magnetic disc, and optical disc.

A module or a model included in the memory 830 may include a program, a model, or an algorithm that is executed according to a control or a command of the processor 820 and is configured to perform operations of deriving output data for input data. Referring to FIG. 8, the memory 830 of the electronic device 810 may include a data filtering module 832, a data augmentation module 834, and a model training module 836. In an embodiment of the disclosure, the data filtering module (832) may be executed by the processor 820 and may generate a second data set by filtering a first data set loaded into the memory 830 based on data for obstacles. In an embodiment of the disclosure, the data augmentation module 834 may be executed by the processor 820 and may generate a third data set by generating augmented data for data that is insufficient in the second data set. In an embodiment of the disclosure, the model training module 836 may be executed by the processor 820 and train an artificial intelligence model by using the third data set. In FIG. 8, the modules 832, 834, and 836 are illustrated as a software configuration included in the memory 830, but the disclosure is not limited thereto. For example, at least some of the modules 832, 834, and 836 may be implemented as separate hardware modules rather than software modules stored in the memory.

The memory 830 of the electronic device 810 may include an artificial intelligence model 838. For example, the memory 830 may include a plurality of weight values that constitute the artificial intelligence model 838. The artificial intelligence model 838 may be a training model trained to infer or predict position information by the model training module 836. For example, the artificial intelligence model 838 may be a training model trained by the model training module 836 through supervised learning, unsupervised learning, semi-supervised learning, or reinforcement learning, but the disclosure is not limited thereto. The artificial intelligence model 838 may include a plurality of neural network layers. Each of the neural network layers may have a plurality of weight values and may perform neural network operations through operations between the plurality of weight values and the operation results of the previous layer. The weight values of the neural network layers may be optimized by the training result of the artificial intelligence model. For example, the weight values may be updated so that a loss value or a cost value obtained by the artificial intelligence model during a training process is reduced or minimized. The artificial intelligence model 838 may include a deep neural network (DNN), for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or deep Q-networks, or the like, but the disclosure is not limited thereto.

The electronic devices 810, 850, and 860 may communicate with each other over a network 840. The network 840 may be configured to enable communication between the electronic devices 810, 850, and 860. For example, the network 840 may be configured as a wired network, such as Ethernet, a wired home network (power line communication), a telephone line communication, and an RS-serial communication, a mobile communication network, a wireless network, such as wireless local area network (WLAN), wireless fidelity (Wi-Fi), or any combination thereof, according to an installation environment. For example, the network 840 may be configured as a short-range communication network (e.g., Bluetooth, Wi-Fi direct, or infrared data association (IrDA)), a long-range communication network (e.g., a cellular network, the Internet, or a computer network (e.g., local area network (LAN) or wide area network (WAN))), or any combination thereof.

In an embodiment of the disclosure, the electronic device 810 may receive training data (e.g., a data set) for training the artificial intelligence model 838 from the electronic device 850 over the network 840. In an embodiment of the disclosure, the electronic device 860 may receive the artificial intelligence model 838 from the electronic device 810 over the network 840. For example, the electronic device 860 may receive data including information for performing position inference by using the artificial intelligence model 838 from the electronic device 810 over the network 840. For example, the electronic device 860 may receive data including neural network information, layer information, inter-layer weight value information, or the like, which constitutes the artificial intelligence model 838, from the electronic device 810 over the network 840. For example, the electronic device 860 may perform an operation of inferring position information by using the artificial intelligence model 838 loaded from the memory 830 to the memory 864.

In FIG. 8, the device 810 that trains the artificial intelligence model, the device 850 that collects the training data, and the device 860 that infers the position information are separately illustrated, but the disclosure is not limited thereto. For example, the device 810 that trains the artificial intelligence model may be the same device as the device 850 that collects the training data. For example, the device 810 that trains the artificial intelligence model may be the same device as the device 860 that infers position information by using the trained artificial intelligence model. For example, the device 850 that collects the training data may be the same device as the device 860 that infers position information by using the artificial intelligence model.

The electronic devices 810, 850, and 860 may include more components than those illustrated in FIG. 8. For example, the electronic devices 810, 850, and 860 may further include a communication interface (or a communication module) for communication with an external device. For example, the electronic device 850 may further include an input device and an input/output interface for receiving user input signals. For example, the electronic device 860 may further include an output device and an input/output interface for outputting position information.

A machine-readable storage medium may be provided in the form of a non-transitory storage medium. The ‘non-transitory storage medium’ is a tangible device and only means not including a signal (e.g., electromagnetic waves). This term does not distinguish between a case where data is semi-permanently stored in a storage medium and a case where data is temporarily stored in a storage medium. For example, the ‘non-transitory storage medium’ may include a buffer in which data is temporarily stored.

A method according to an embodiment of the disclosure may be provided by being included in a computer program product. The computer program product may be traded between a seller and a buyer as commodities. The computer program product may be distributed in the form of a machine-readable storage medium (e.g., compact disc read-only memory (CD-ROM)), or may be distributed (e.g., downloaded or uploaded) online either via an application store or directly between two user devices (e.g., smartphones). In the case of the online distribution, at least a part of a computer program product (e.g., downloadable app) is stored at least temporarily on a machine-readable storage medium, such as a server of a manufacturer, a server of an application store, or memory of a relay server, or may be temporarily generated.

A method performed by an electronic device, according to an embodiment of the disclosure, may include identifying a first data set including first signal data for a signal device collected at a first position by a user terminal, data for an obstacle located within a certain distance from the user terminal when collecting the first signal data, and second signal data for the signal device collected at a second position. In an embodiment of the disclosure, the method may include generating a second data set by filtering out the first signal data from the first data set, based on (or by using) the data for the obstacle. In an embodiment of the disclosure, the method may include generating a third data set by generating augmented data for the first position and the signal device, based on (or by using) the second signal data. In an embodiment of the disclosure, the method may include training an artificial intelligence model for inferring position information by using the third data set. According to an embodiment of the disclosure, an artificial intelligence model having improved inference capability may be obtained by training an artificial intelligence model by using training data from which data affected by an obstacle is removed.

In an embodiment of the disclosure, the generating of the third data set may include generating the augmented data for the first position and the signal device, based on (or by using) the second signal data, by using a Gaussian process regression (GPR) algorithm. According to an embodiment of the disclosure, when signal data for a specific position is filtered from training data, augmented data may be generated so as to replace signal data filtered by using signal data unfiltered from the training data, and the generated augmented data may be used to train the artificial intelligence model. Therefore, the loss of training data due to filtering may be compensated for.

In an embodiment of the disclosure, the generating of the third data set may include generating augmented data for the second position and the signal device, based on (or by using) the second signal data, by using a GPR algorithm. According to an embodiment of the disclosure, in order to increase the amount of training data for a specific position, augmented data for the corresponding position may be additionally generated and used for training, based on signal data collected for the corresponding position. Therefore, the amount of training data for the specific position may increase.

In an embodiment of the disclosure, the first data set may include third signal data for the signal device collected at a third position. In this case, the generating of the third data set may include generating augmented data for the third position and the signal device, based on (or by using) the second signal data, by using a GPR algorithm. According to an embodiment of the disclosure, data for another position may be generated as augmented data by using the signal data collected at the specific position, and the generated augmented data may be used to train an artificial intelligence model. For example, when training data for the specific position is insufficient, the amount of training data for the specific position may be increased by using training data for another position.

In an embodiment of the disclosure, the generating of the third data set may include generating augmented data for a fourth position and the signal device, which is independent of signal data included in the first data set, based on (or by using) the second signal data, by using a GPR algorithm. According to an embodiment of the disclosure, when signal data for a specific position is not collected, training data for the specific position may be generated by using signal data collected at another position and may be used to train an artificial intelligence model. Therefore, the artificial intelligence model may be trained even at positions where data is not collected.

In an embodiment of the disclosure, the first signal data may include a value of signal strength of the signal device measured at the first position. In an embodiment of the disclosure, the generating of the second data set may include identifying a filtering reference value for the first signal data, based on (or by using) the data for the obstacle. In an embodiment of the disclosure, the generating of the second data set may include removing the first signal data, based on (or in response to) determining that the value of the signal strength is less than or equal to the filtering reference value. In an embodiment of the disclosure, the performance of the artificial intelligence model may be adjusted by adjusting the degree of filtering of training data of the artificial intelligence model.

In an embodiment of the disclosure, the filtering reference value may be determined based on (or by using) at least one of the number of obstacles or the value of the data for the obstacle. In an embodiment of the disclosure, the filtering reference value for training data may be applied differently depending on a degree of influence of obstacles.

In an embodiment of the disclosure, the data for the obstacle may include at least one of a value of a short-range communication signal strength of another user terminal or a geo-magnetic change amount due to the obstacle. In an embodiment of the disclosure, the influence of a non-stationary obstacle, i.e., a movable obstacle, may be detected.

In an embodiment of the disclosure, the generating of the third data set may include generating the augmented data for the first position and the signal device, based on (or in response to) determining that a total number of signal data for the first position and the signal device included in the second data set is less than a threshold value. In an embodiment of the disclosure, the minimum performance of the artificial intelligence model may be guaranteed by ensuring a certain amount of training data or more.

A program for causing a computer to perform a method of training an artificial intelligence model for inferring position information, according to at least some of the embodiments described above, may be recorded on a computer-readable recording medium.

A method performed by a user terminal, according to an embodiment of the disclosure, may include identifying signal data for one or more signal devices and data for an obstacle located within a certain distance from the user terminal. In an embodiment of the disclosure, the method may include calculating first position prediction data, based on (or using) the signal data for the one or more signal devices, by using the artificial intelligence model for inferring position information. In an embodiment of the disclosure, the method may include applying a weight value to the first position prediction data, based on (or by using) the data for the obstacle. In an embodiment of the disclosure, the method may include determining the position information of the user terminal, based on (or by using) the first position prediction data to which the weight value is applied.

In an embodiment of the disclosure, the method may include identifying second position prediction data. In an embodiment of the disclosure, the method may include applying a weight value to the second position prediction data, based on (or by using) the data for the obstacle. In an embodiment of the disclosure, the determining of the position information may include determining the position information of the user terminal, based on (or by using) the first position prediction data to which the weight value is applied and the second position prediction data to which the weight value is applied.

In an embodiment of the disclosure, the signal data for the one or more signal devices may include values of signal strengths of the one or more signal devices. In an embodiment of the disclosure, the data for the obstacle may include at least one of a value of a short-range communication signal strength of another user terminal or a geo-magnetic change amount due to the obstacle. In an embodiment of the disclosure, the weight value applied to the first position prediction data may be determined based on (or by using) at least one of the number of obstacles or the value of the data for the obstacle.

A program for causing a computer to perform a method of inferring position information of a user terminal, according to at least some of the embodiments described above, may be recorded on a computer-readable recording medium.

An electronic device according to an embodiment of the disclosure may include memory that stores one or more instructions and at least one processor that execute the at least one instructions stored in the memory. In an embodiment of the disclosure, the at least one processor may be configured to execute the one or more instructions to identify a first data set including first signal data for a signal device collected at a first position by a user terminal, data for an obstacle located within a certain distance from the user terminal when collecting the first signal data, and second signal data for the signal device collected at a second position. In an embodiment of the disclosure, the at least one processor may be configured to generate a second data set by filtering out the first signal data from the first data set, based on (or by using) the data for the obstacle. In an embodiment of the disclosure, the at least one processor may be configured to generate a third data set by generating augmented data for the first position and the signal device, based on (or by using) the second signal data. In an embodiment of the disclosure, the at least one processor may be configured to train the artificial intelligence model by using the third data set.

In an embodiment of the disclosure, the at least one processor may generate augmented data for the first position and the signal device, based on (or by using) the second signal data, by using a GPR algorithm. In an embodiment of the disclosure, the at least one processor may generate augmented data for the second position and the signal device, based on (or by using) the second signal data, by using a GPR algorithm. In an embodiment of the disclosure, the first data set may include third signal data for the signal device collected at a third position. In this case, the at least one processor may generate augmented data for the third position and the signal device, based on (or by using) the second signal data, by using a GPR algorithm. In an embodiment of the disclosure, the at least one process may generate augmented data for a fourth position and the signal device, which is independent of signal data included in the first data set, based on (or by using) the second signal data, by using a GPR algorithm.

In an embodiment of the disclosure, the at least one processor may include identifying a filtering reference value for the first signal data, based on (or by using) the data for the obstacle. In an embodiment of the disclosure, the at least one processor may include removing the first signal data, based on (or in response to) determining that the value of the signal strength is less than or equal to the filtering reference value.

In an embodiment of the disclosure, the at least one processor may generate the augmented data for the first position and the signal device, based on (or in response to) determining that a total number of signal data for the first position and the signal device included in the second data set is less than a threshold value.

An electronic device according to an embodiment of the disclosure may include memory that stores one or more instructions and at least one processor that execute the at least one instructions stored in the memory. In an embodiment of the disclosure, the at least one processor may be further configured to identify signal data for one or more signal devices and data for an obstacle located within a certain distance from the user terminal. In an embodiment of the disclosure, the at least one processor may calculate first position prediction data, based on (or using) the signal data for the one or more signal devices, by using the artificial intelligence model for inferring position information. In an embodiment of the disclosure, the at least one processor may apply a weight value to the first position prediction data, based on (or by using) the data for the obstacle. In an embodiment of the disclosure, the at least one processor may determine the position information of the user terminal, based on (or by using) the first position prediction data to which the weight value is applied.

In an embodiment of the disclosure, the at least one processor may identify second position prediction data. In an embodiment of the disclosure, the at least one processor may apply a weight value to the second position prediction data, based on (or by using) the data for the obstacle. In an embodiment of the disclosure, the at least one processor may include determining the position information of the user terminal, based on (or by using) the first position prediction data to which the weight value is applied and the second position prediction data to which the weight value is applied.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device, the method comprising:
identifying a first data set comprising first signal data for a signal device collected at a first position by a user terminal, data for an obstacle located within a certain distance from the user terminal when collecting the first signal data, and second signal data for the signal device collected at a second position;
generating a second data set by filtering out the first signal data from the first data set, based on the data for the obstacle;
generating a third data set by generating augmented data for the first position and the signal device, based on the second signal data; and
training an artificial intelligence model for inferring position information by using the third data set.

2. The method of claim 1, wherein the generating of the third data set comprises generating the augmented data for the first position and the signal device, based on the second signal data, by using a Gaussian process regression (GPR) algorithm.

3. The method of claim 1, wherein the generating of the third data set comprises generating augmented data for the second position and the signal device, based on the second signal data, by using a Gaussian process regression (GPR) algorithm.

4. The method of claim 1,
wherein the first data set comprises third signal data for the signal device collected at a third position, and
wherein the generating of the third data set comprises generating augmented data for the third position and the signal device, based on the second signal data, by using a Gaussian process regression (GPR) algorithm.

5. The method of claim 1, wherein the generating of the third data set comprises generating augmented data for a fourth position and the signal device, which is independent of signal data included in the first data set, based on the second signal data, by using a Gaussian process regression (GPR) algorithm.

6. The method of claim 1,
wherein the first signal data comprises a value of signal strength of the signal device measured at the first position, and
wherein the generating of the second data set comprises:
identifying a filtering reference value for the first signal data, based on the data for the obstacle, and
removing the first signal data, based on determining that the value of the signal strength is less than or equal to the filtering reference value.

7. The method of claim 6, wherein the filtering reference value is determined based on at least one of a number of the obstacle or a value of the data for the obstacle.

8. The method of claim 1, wherein the data for the obstacle comprises at least one of a value of short-range communication signal strength of another user terminal or a geo-magnetic change amount due to the obstacle.

9. The method of claim 1, wherein the generating of the third data set comprises generating the augmented data for the first position and the signal device, based on determining that a total number of signal data for the first position and the signal device included in the second data set is less than a threshold value.

10. An electronic device comprising:
memory storing one or more computer programs; and
at least one processor communicatively coupled to the memory,
wherein the one or more computer programs include computer-executable instructions that, when executed by the at least one processor individually or collectively, cause the electronic device to:
identify a first data set comprising first signal data for a signal device collected at a first position by a user terminal, data for an obstacle located within a certain distance from the user terminal when collecting the first signal data, and second signal data for the signal device collected at a second position,
generate a second data set by filtering out the first signal data from the first data set, based on the data for the obstacle,
generate a third data set by generating augmented data for the first position and the signal device, based on the second signal data, and
train an artificial intelligence model for inferring position information by using the third data set.

11. The electronic device of claim 10, wherein the one or more computer programs further include computer-executable instructions that, when executed by the at least one processor individually or collectively, cause the electronic device to generate the augmented data for the first position and the signal device, based on the second signal data, by using a Gaussian process regression (GPR) algorithm.

12. The electronic device of claim 10, wherein the one or more computer programs further include computer-executable instructions that, when executed by the at least one processor individually or collectively, cause the electronic device to generate augmented data for the second position and the signal device, based on the second signal data, by using a Gaussian process regression (GPR) algorithm.

13. The electronic device of claim 10,
wherein the first data set comprises third signal data for the signal device collected at a third position, and
wherein the one or more computer programs further include computer-executable instructions that, when executed by the at least one processor individually or collectively, cause the electronic device to generate augmented data for the third position and the signal device, based on the second signal data, by using a Gaussian process regression (GPR) algorithm.

14. The electronic device of claim 10, wherein the one or more computer programs further include computer-executable instructions that, when executed by the at least one processor individually or collectively, cause the electronic device to generate augmented data for a fourth position and the signal device, which is independent of signal data included in the first data set, based on the second signal data, by using a Gaussian process regression (GPR) algorithm.

15. The electronic device of claim 10,
wherein the first signal data comprises a value of signal strength of the signal device measured at the first position, and
wherein the one or more computer programs further include computer-executable instructions that, when executed by the at least one processor individually or collectively, cause the electronic device to:
identify a filtering reference value for the first signal data, based on the data for the obstacle, and
remove the first signal data, based on determining that the value of the signal strength is less than or equal to the filtering reference value.

16. The electronic device of claim 15, wherein the filtering reference value is determined based on at least one of a number of the obstacle or a value of the data for the obstacle.

17. The electronic device of claim 10, wherein the data for the obstacle comprises at least one of a value of short-range communication signal strength of another user terminal or a geo-magnetic change amount due to the obstacle.

18. The electronic device of claim 10, wherein the one or more computer programs further include computer-executable instructions that, when executed by the at least one processor individually or collectively, cause the electronic device to generate the augmented data for the first position and the signal device, based on determining that a total number of signal data for the first position and the signal device included in the second data set is less than a threshold value.

19. One or more non-transitory computer-readable storage media storing one or more computer programs including computer-executable instructions that, when executed by one or more processors of an electronic device individually or collectively, cause the electronic device to perform operations, the operations comprising:
identifying a first data set comprising first signal data for a signal device collected at a first position by a user terminal, data for an obstacle located within a certain distance from the user terminal when collecting the first signal data, and second signal data for the signal device collected at a second position;
generating a second data set by filtering out the first signal data from the first data set, based on the data for the obstacle;
generating a third data set by generating augmented data for the first position and the signal device, based on the second signal data; and
training an artificial intelligence model for inferring position information by using the third data set.

20. The one or more non-transitory computer-readable storage media of claim 19, wherein the generating of the third data set comprises generating the augmented data for the first position and the signal device, based on the second signal data, by using a Gaussian process regression (GPR) algorithm.
